(19) United States
(12) Patent Application Publication
(10) Pub. No.: US 2013/0154920 A1
(43) Pub. Date: Jun. 20, 2013

(54) GUITAR INPUT AND OUTPUT DOCK FOR A TABLET COMPUTER

(71) Applicants: Daniel I. Radin, New York, NY (US); David C. Gill, North Providence, RI (US); John E. O'Donnell, Ft. Lauderdale, FL (US); Matthew J. Stith, Greenville, RI (US)

(72) Inventors: Daniel I. Radin, New York, NY (US); David C. Gill, North Providence, RI (US); John E. O'Donnell, Ft. Lauderdale, FL (US); Matthew J. Stith, Greenville, RI (US)

(73) Assignee: ALESIS, L.P., Cumberland, RI (US)

(21) Appl. No.: 13/610,215

(22) Filed: Sep. 11, 2012

Related U.S. Application Data
(60) Provisional application No. 61/570,504, filed on Dec. 14, 2011.

(51) Int. Cl. G09G 5/00

(52) U.S. Cl. 345/156

(57) ABSTRACT

A guitar input and output dock for a tablet computer is disclosed. The guitar input and output dock includes a dock portion having a cavity configured and arranged to receive a tablet computer therein. The dock portion includes a guitar input, an audio output, and a foot pedal controller input. A foot pedal controller having a foot pedal is electrically connected to the foot pedal controller input. An electrical circuit in the dock portion is configured and arranged to transmit audio input from the guitar input and pedal press information from foot pedal controller to the tablet computer for audio processing and transmit the processed audio from the tablet computer to the audio output.

### CROSS-REFERENCE TO RELATED APPLICATION

This patent document claims priority to earlier filed U.S. Provisional Patent Application Ser. No. 61/570,504, filed on Dec. 14, 2011, the entire contents of which are incorporated herein by reference.

### BACKGROUND

1. Technical Field

This patent document relates generally to audio input and output devices for electronically recording instruments and more particularly to an audio input and output device for a guitar to permit audio performing, recording, processing and playback with a tablet computer.

2. Background of the Related Art

Tablet computers, such as the iPad® brand tablet computer, have become popular devices to store and play back music. Tablet computers also have the ability to apply music effects on the audio signals received. It would therefore desirable to use tablet computer to record, process, and playback music during guitar sessions.

Although prior art products exist to allow guitarists to use a tablet computer to record and process their music, these prior art devices have disadvantages. First, these prior art devices incorporate the tablet computer directly into a foot pedal, which is located on the floor or are connected through a cable. In either situation, the tablet computer, a fragile and expensive piece of equipment, is left vulnerable to possible damage by being stepped on.

Second, the audio input and output capabilities of a tablet computer are very limited, because tablet computers lack industry standard audio input and output connectors used with guitars.

Third, the tablet computers are not used to process the audio, but merely to function as a controller for the audio effects. As a result, the prior art devices are more expensive as they must include circuitry to apply the audio effects to the guitar and auxiliary inputs.

Therefore, there is a perceived need in the industry for a guitar audio input and output device for a tablet computer that provides a more secure arrangement for the fragile tablet computer and provides a wider range of input and output capabilities than provided by the tablet computer, and also uses the growing processing power of the tablet computers to process the audio.

### SUMMARY

The guitar input and output dock (“guitar dock”) solves the problems of the prior art by providing a way to securely use a tablet computer with a guitar. It allows the musician to position a dock portion in a secure location (i.e. not on the floor) with the tablet computer housed securely within, and a separate foot pedal controller that is on the floor, which plugs into the dock portion. The guitar dock can then be used with the numerous guitar applications to either record to the tablet computer or get music effects from the tablet computer. The guitar dock can be connected to any standard playback set up (e.g. a mixer or pa, and the like).

### BRIEF DESCRIPTION OF THE DRAWINGS

These and other features, aspects, and advantages of the present invention will become better understood with reference to the following description, appended claims, and accompanying drawings where:

FIGS. 1A and 1B, together, is a schematic diagram of the electrical operation of the guitar audio input and output dock;

FIG. 2 is a perspective view of the dock portion of the guitar audio input and output dock;

FIG. 3 is a rear and right side perspective view of the dock portion of the guitar audio input and output dock;

FIG. 4 is a bottom, right, rear perspective view of the dock portion of the guitar audio input and output dock; and

FIG. 5 is a perspective view of the dock portion illustrating the operation of the door and insertion of a tablet computer therein; and

FIG. 6 is a perspective view of the foot pedal controller of the guitar audio input and output dock.

### DESCRIPTION OF THE PREFERRED EMBODIMENT

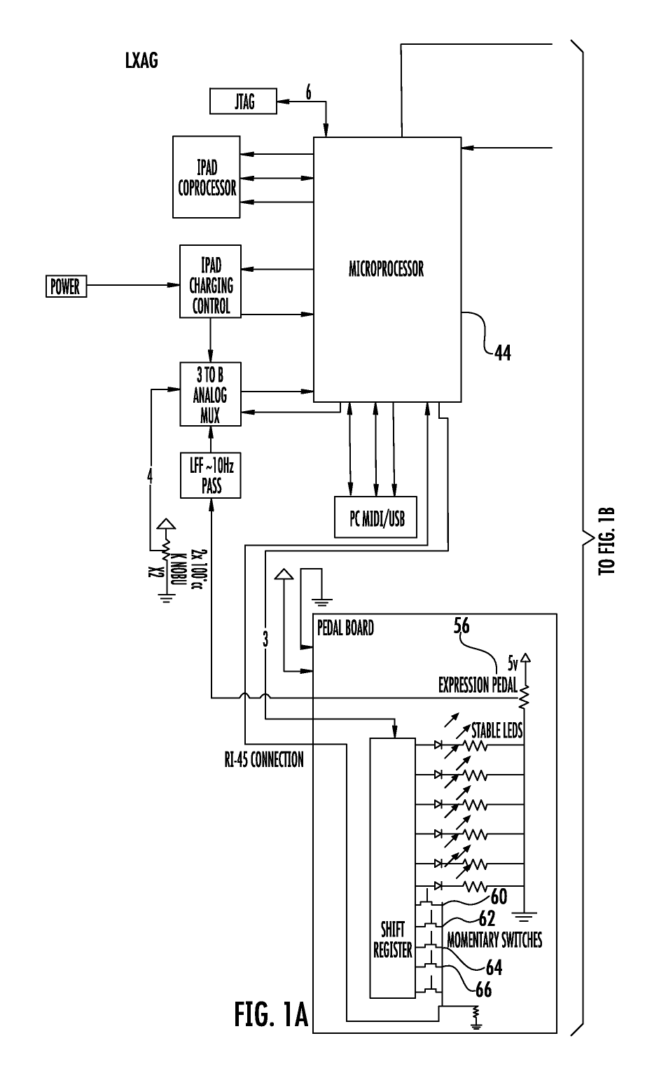

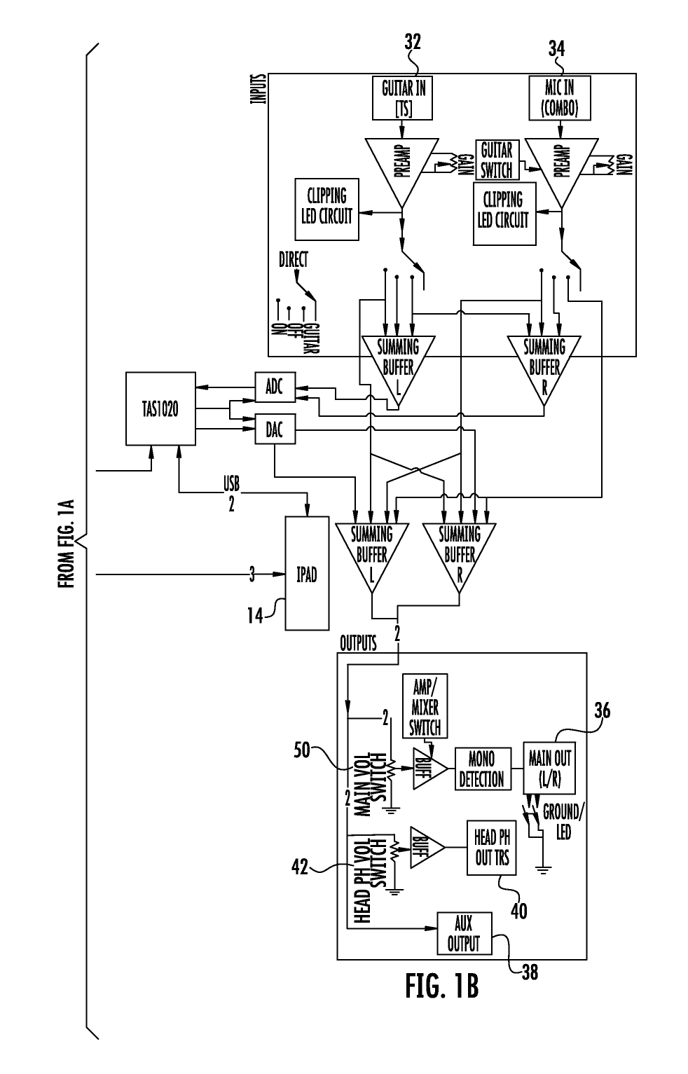

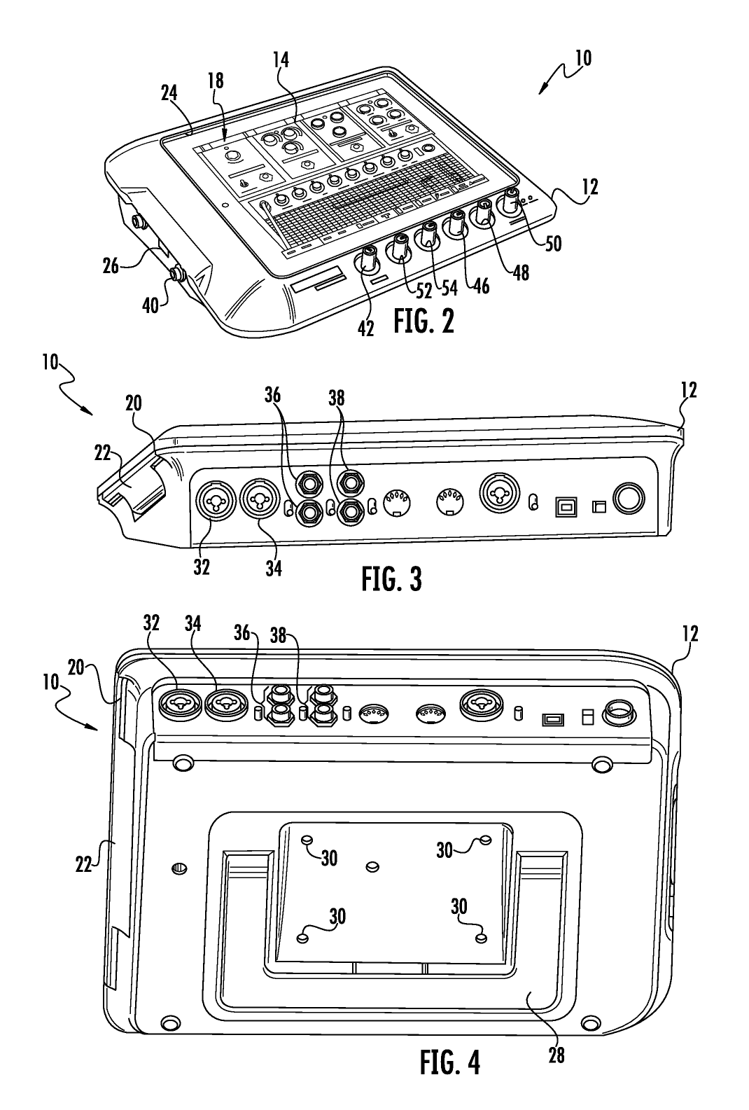

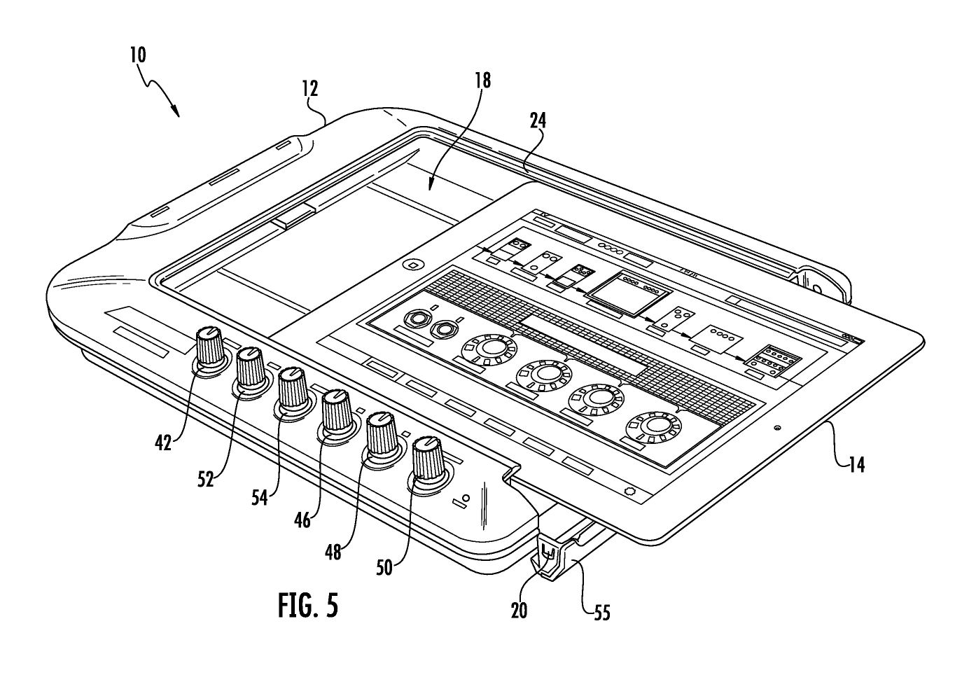

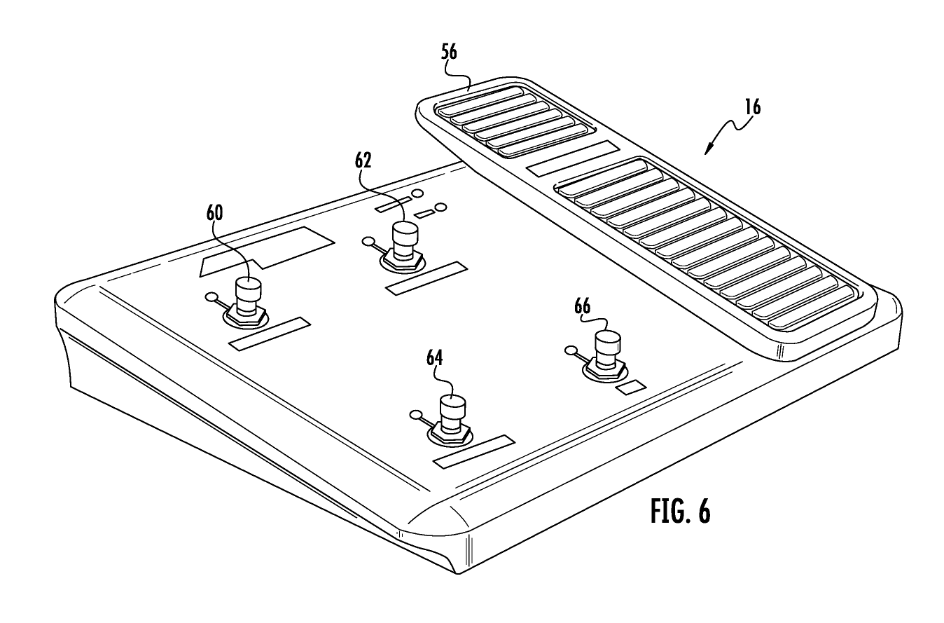

Referring now to FIGS. 1A, 1B and 2-6, an embodiment of the guitar dock for a tablet computer is shown generally at 10. The guitar dock 10 includes a dock portion 12 that is configured and arranged to receive a tablet computer 14 docked therein (best seen in FIG. 2-4) and a foot pedal controller 16 (best seen in FIG. 6).

The dock portion 12 includes a cavity 18 to receive a tablet computer 14 therein. A slot 20 in the dock portion 12 permits the tablet computer 14 to be slid into the cavity 18. A door 22 on the side of the dock portion 12 closes the slot 20 and locks the tablet computer 14 in the cavity 18. A window 24 is formed through the dock portion 12 and into the cavity 18 to permit access to a touch screen of the tablet computer 12.

Industry-standard audio input and output connectors are included on the dock for connecting various audio cables, such as microphones, ⅛″ cables, ¼″ cables, RCA cables, MIDI, USB-B or XLR cables, and the like. The number and style of connectors may be varied as desired. The dock portion 12 also includes a foot pedal controller input 26 to receive inputs form a foot pedal controller 16. One or more different style audio input and output connectors may be used to avoid the use of adapters.

As can be seen, the dock portion 12 can be mounted on a stand or placed on top of an amplifier with a flip out stand 28 (best seen in FIG. 4). The flip out stand 28 angles the dock portion so that the touch screen of the tablet computer 14 may be oriented to a preferred viewing angle by the musician. Alternatively, the dock portion 12 may be mounted via mounting holes 30 to a stand or other structure. The musician can connect his guitar to the device through a first input 32 and then either a second guitar, microphone, or other device into the second input 34. Although two inputs 32, 34 are shown, additional audio inputs may be provided.

The audio signals from the inputs 32, 34 are then sent digitally to the tablet computer 14, direct to a main output 36 and an optional auxiliary output 38, or a blend, such as the guitar routed to and from the tablet computer 14 with the second input 34 routed direct to the outputs 32,34, which permits the application of music effects by the tablet computer 14 to one audio input and unprocessed audio to the other audio input. For example, a reverb effect could be applied to the guitar input through the first input 32 with the vocals from the microphone from the second input 34 unmodified.

In addition to the main audio output 36 and auxiliary output 38, a headphone output 40, with its own volume control 42, is also provided for use during practice sessions.

A microprocessor 44 is included to communicate with the tablet computer 14, authenticate the device as a valid peripheral, and set up the USB communication. The initial tablet computer communication can occur through the tablet computer's 12 serial interface or through the tablet computer's 12 USB interface, as is known in the art.

The dock portion 12 also includes a number of knobs to permit easy adjustment of volume 46, 48 of either audio input 32, 34, headphone output volume 42, and a master volume 50 of the output. Other effects, such as equalizers, may be assigned to the other knobs to permit easy adjustment of frequently used music settings, such as bass and treble, for instance. Gain knobs 521 54 may also be included for each audio input 32, 34.

The foot pedal controller 16 includes a foot pedal 56 and several foot switches 60, 62, 64, 66. The foot pedal 56 allows the musician to apply a special effect to the guitar audio. Activating the foot pedal 56 sends signals to the microprocessor 44, which detects the pedal press. The foot pedal 56 may be configured to provide analog or digital output of the pedal position. The microprocessor 44 transmits the pedal press event to the tablet computer 14. A guitar application running on the tablet computer 14 then applies the special effect to the guitar input prior to routing the guitar input to one of the audio outputs 36, 38.

The foot switches 60, 62, 64, 66 permit the musician to easily switch special effects and other settings with a tap of the foot instead of approaching and manipulating the tablet computer 14. Specifically, the microprocessor 44 detects the presses of the various foot switches 60, 62, 64, 66 and transmits the foot switch press events to the tablet computer 44. The guitar application running on the tablet computer 44 then takes the appropriate action based on the particular foot switch pressed, e.g. switch special effects, disable special effects, etc.

As can be seen, the guitar dock 12 permits a musician to play with his guitar using a tablet computer 14 to record, process and playback audio. The dock portion 12 separate from the foot pedal controller 16 provides a safe means to place the tablet computer 14 off of the floor to remove the chance it is accidentally stepped on. Furthermore, the additional connectors and controls provide by the guitar audio dock 10 makes the tablet computer 14 a flexible alternative to more expensive specialized audio equipment.

It would be appreciated by those skilled in the art that various changes and modifications can be made to the illustrated embodiments without departing from the spirit of the invention. All such modifications and changes are intended to be within the scope of the invention.

What is claimed is:

1. A guitar input and output dock for a tablet computer, comprising:
a dock portion having a cavity configured and arranged to receive a tablet computer therein;
a guitar input on the dock portion;
an audio output on the dock portion;
a foot pedal controller input on the dock portion;
a foot pedal controller having a foot pedal, the foot pedal controller electrically connected to the foot pedal controller input; and
an electrical circuit in the dock portion configured and arranged to transmit audio input from the guitar input and pedal press information from foot pedal controller to the tablet computer for audio processing and transmit the processed audio from the tablet computer to the audio output.

2. The guitar input and output dock of claim 1, further comprising a window in the dock potion into the cavity configured and arranged to make a touch screen of the tablet computer accessible.

3. The guitar input and output dock of claim 1, further comprising a slot on the dock portion into the cavity configured and arranged for the tablet computer to be slid therethrough into the cavity.

4. The guitar input and output dock of claim 3, further comprising a door on a side of the dock portion configured and arranged to close the slot and lock the tablet computer in the cavity.

5. The guitar input and output dock of claim 1, further comprising a microphone input on the dock portion and the electrical circuit is further configured to transmit audio input from the microphone input to the tablet computer for audio processing and transmit the processed audio from the tablet computer to the audio output.

6. The guitar input and output dock of claim 1, further comprising a flip out stand on the dock portion.

7. The guitar input and output dock of claim 5, further comprising a selectable auxiliary audio output on the dock portion and electrically connector to the electrical circuit configured and arranged to receive audio selectively from one of the guitar input, microphone input and processed audio from the tablet computer.

8. The guitar input and output dock of claim 1, further comprising a plurality of foot switches on the foot pedal controller and the electrical circuit is further configured to transmit foot switch position from the foot pedal controller to the tablet computer for audio processing and transmit the processed audio from the tablet computer to the audio output.

9. The guitar input and output dock of claim 1, wherein the foot pedal controller input, guitar input and audio output are connectors selected from the group consisting essentially of ⅛″ connectors, ¼″ connectors, RCA connectors, MIDI connectors, USB-B connectors and XLR connectors.

10. The guitar input and output dock of claim 7, wherein the foot pedal controller input, guitar input, microphone input and audio output are connectors selected from the group consisting essentially of ⅛″ connectors, ¼″ connectors, RCA connectors, MIDI connectors, USB-B connectors and XLR connectors.

11. A guitar input and output dock for a tablet computer, comprising:
a dock portion having a cavity configured and arranged to receive a tablet computer therein, the dock portion having a slot into the cavity configured and arranged for the tablet computer to be slid therethrough into the cavity, the dock portion further having a window therethrough into the cavity configured and arranged to make a touch screen of the tablet computer accessible;
a door on a side of the dock portion configured and arranged to close the slot and lock the tablet computer in the cavity;
a guitar input on the dock portion;
an audio output on the dock portion;
a microphone input on the dock portion
a foot pedal controller input on the dock portion;
a foot pedal controller having a foot pedal, the foot pedal controller connected to the foot pedal controller input; and
an electrical circuit in the dock portion configured and arranged to transmit audio input from the guitar input and microphone input, and pedal press information from foot pedal controller to the tablet computer for audio processing and transmit the processed audio from the tablet computer to the audio output.

12. The guitar input and output dock of claim 11, further comprising a flip out stand on the dock portion.

13. The guitar input and output dock of claim 11, further comprising a plurality of foot switches on the foot pedal controller and the electrical circuit is further configured to transmit foot switch position from the foot pedal controller to the tablet computer for audio processing and transmit the processed audio from the tablet computer to the audio output.

14. The guitar input and output dock of claim 11, further comprising a selectable auxiliary audio output on the dock portion and electrically connector to the electrical circuit configured and arranged to receive audio selectively from one of the guitar input, microphone input and processed audio from the tablet computer.

15. The guitar input and output dock of claim 11, wherein the foot pedal controller input, guitar input, microphone input and audio output are connectors selected from the group consisting essentially of ⅛″ connectors, ¼″ connectors, RCA connectors, MIDI connectors, USB-B connectors and XLR connectors.
